(19) United States
(12) Patent Application Publication
(10) Pub. No.: US 2017/0115376 A1
(43) Pub. Date: Apr. 27, 2017

(54) METHOD FOR EFFECTIVELY ESTIMATING THREE-DIMENSIONAL LOCATION BY USING TRILATERATION IN WIRELESS NETWORK, AND RECORDING MEDIUM IN WHICH PROGRAM IS RECORDED FOR CARRYING OUT SAME

(71) Applicant: SNU R&DB FOUNDATION, Seoul (KR)

(72) Inventors: Seong Cheol KIM, Seoul (KR); Jung Kyu LEE, Seoul (KR); Young Joon KIM, Seoul (KR)

(73) Assignee: SNU R&DB Foundation, Seoul (KR)

(21) Appl. No.: 15/301,970

(22) PCT Filed: Sep. 3, 2014
(86) PCT No.: PCT/KR2014/008238

§ 371 Date: Oct. 5, 2016

(30) Foreign Application Priority Data
Apr. 23, 2014 (KR) 10-2014-0048592

(51) Int. Cl. G01S 5/14; H04B 17/318; H04W 4/02

(52) U.S. Cl. CPC G01S 5/14; H04W 4/023; H04B 17/318

(57) ABSTRACT

Disclosed is a technique capable of effectively estimating a three-dimensional location of a target node through a geometric access by using location information of three anchor nodes. The height of a tetrahedron is calculated. Projected estimated distances, obtained by projecting the estimated distances on a plane H formed by the three anchor nodes, and coordinate values of the three anchor nodes converted on a second coordinate system of the plane H are obtained, and then trilateration is performed using the projected estimated distances and the converted coordinate values so as to calculate an estimated location, projected on the plane H, of the target node. A coordinate value of the calculated estimated location is converted into a coordinate value on a first coordinate system and then the height of the tetrahedron is reflected thereto so as to obtain a coordinate value of the three-dimensional estimated location of the target node.

### FIELD OF TECHNOLOGY

The present invention relates to wireless estimating of location, more specifically to a technology for estimating simply and precisely using a range-based algorithm in order to provide a location based service (LBS) more precisely.

### BACKGROUND OF TECHNOLOGY

As the interest in smartphones increases explosively, a location based service (LBS) is receiving attention a lot. For example, the location-sensitive applications such as augmented reality, medical care, home network, and monitoring application are popular. In order to provide the LBS of good quality, the positioning of a user requesting services must be accomplished very accurately. Accurate positioning enables unmanned system finding information for themselves through angle and wireless sensor network and sharing the information.

Most of the conventional positioning algorithms were known to be able to estimate the locations pretty accurately and solve geometrical problems, but most of them focus on two-dimensional (2D) analysis only. However, the accuracy of the 2D positioning algorithms is deteriorated in a real three-dimensional (3D) environment such as an indoor environment in a short distance. As a latest research, a hybrid algorithm was suggested, which uses distance estimation and angle estimation in complex ways for the three-dimensional positioning. As another method, in order to reduce the complexity more than the 3D linear least square (LLS) algorithm, a 3D positioning method using six anchor nodes was suggested.

However, the wireless positioning technologies known in prior arts had problems as follows. First, the location-estimating system had a complex structure. The 3D positioning algorithm based on estimated distance was suggested recently, it needed a separate additional hardware for measuring the angle of arrival (AOA) of wireless signal or additional anchor nodes for the positioning. In order to estimate the 3D location, ‘not less than four’ anchor nodes are needed. If the number of nodes necessary for 3D location estimation is large, it needs to install as many nodes as possible, and therefore it results in a higher cost and also an increased complexity of the positioning system.

In installing of anchor nodes, the calculation error can be reduced by providing height difference. If estimating the location linearly without considering the height difference, a problem having no inverse matrix, so called a singular matrix problem, takes places frequently, and the iteration method of a relatively high complexity must be used to solve that, which is not practical.

Also, for example, in case of a sensor network, in estimating a 3D location of a node, in order to use less nodes than those of the conventional 3D positioning technologies, additional hardware such as a multiple antenna for angle information as well as location-estimating, a sensor for obtaining a height information, etc. are needed, this makes it difficult to realize with a sensor network having limited hardware, for those affect hardware size as well as cost problem and the complexity of the location-estimating system.

### DETAILED DESCRIPTION OF THE INVENTION

### Problems to Solve

The invention is to provide a Method For Three-Dimensional distance-based wireless positioning And Recording Medium In Which Program Is Recorded For Carrying Out Same, which lowers the number of necessary anchor nodes and the complexity of positioning system, simplifying calculation of positioning information, and increases the accuracy of the system, by estimating effectively the 3D location-estimating of a target node through geometric approach using location information of three anchor nodes only without additional hardware.

### Solutions to Problems

According to an aspect of the invention for accomplishing the above goals, a method for estimating a 3D location of target node in a wireless network having at least three anchor nodes with coordinate values known in an original first coordinate system and a target node with 3D coordinate values unknown in the first coordinate system, the method comprising steps for: calculating three estimated distances (\hat{d}ᵢ) between the target node and each of the three anchor nodes using information of wireless signals received among the nodes; calculating a volume (V_{T}) of a tetrahedron formed by the three estimated distances (\hat{d}ᵢ) and three distances (dᵢⱼ) among the three anchor nodes and a base area (A_{V}) of the tetrahedron formed by the three anchor nodes and calculating a height (ĥ) using the volume V of the tetrahedron and the base area A of the tetrahedron; calculating three projected estimated distances (\hat{d}ₚᵢ) projecting the three estimated distances (\hat{d}ᵢ) onto a flat surface formed by the three anchor nodes respectively using a Pythagorean Theorem; converting coordinate values of the three anchor nodes in a first coordinate system to coordinate values in a second coordinate system defined by the basis vector in the plane; calculating coordinate values (\hat{P}_{cB}) of an estimated location projected on the plane of the target node by performing the trilateration using coordinate values converted into the second coordinate system of the three anchor nodes and three projected estimated distances (\hat{d}ₚᵢ); converting the coordinate values (\hat{P}_{cB}) of the projected estimated location to coordinate values (\hat{P}_{cA}) in the first coordinate system; and calculating coordinate values (\hat{P}_{3D}) of a 3D estimated location in the first coordinate system of the target node by reflecting a height (ĥ) of the tetrahedron to the coordinate values (\hat{P}_{cA}).

In the method for estimating a 3D location of target node, a coordinate conversion of the three anchor nodes is performed by using a coordinate conversion matrix from the first coordinate system to the second coordinate system. The coordinate conversion to the first coordinate system is performed by using an inverse coordinate conversion matrix of the coordinate conversion matrix.

The coordinate conversion matrix may be obtained by steps for: finding equation of the plane formed by the three anchor nodes by using the coordinate values of the three anchor nodes; finding the basis vector of the plane defined by the three anchor nodes by using the equation of the plane; and finding a coordinate conversion matrix between the first coordinate system and the second coordinate system formed by the basis vector of the plane.

In the method for estimating a 3D location of target node, the trilateration may be a two-dimensional linear least squares (LLS).

In the method for estimating a 3D location of target node, the information of the wireless signals may be an information of received signal strength (RSS) or a time of arrival (ToA) of signals received between each of the three anchor nodes and the target node.

In the method for estimating a 3D location of target node, the basis vector of the plane may be obtained from the equation of plane formed by the specific three anchor nodes.

In the method for estimating a 3D location of target node, the 3D location estimation method of the target node may be realized by a positioning application program, and wherein the coordinate values (\hat{P}_{3D}) of the 3D estimated location of the target node is calculated by a computing means executing the positioning application program.

According to another aspect of the invention for achieving the above goals, a recording medium recorded with and to be read by a computing means a positioning application program for 3D location estimation of a target node in a wireless network having at least three anchor nodes with coordinate values known in an original first coordinate system and a target node with 3D coordinate values unknown in the first coordinate system is provided, and the positioning application program comprising: a function for calculating three estimated distances (\hat{d}ᵢ) between the target node and each of the three anchor nodes using information of wireless signals received among the nodes; a function for calculating a volume (V_{T}) of a tetrahedron formed by the three estimated distances (\hat{d}ᵢ and three distances (dᵢⱼ) among the three anchor nodes and a base area (A_{V}) of the tetrahedron formed by the three anchor nodes and calculating a height (ĥ) using the volume V of the tetrahedron and the base area A of the tetrahedron; a function for calculating three projected estimated distances (\hat{d}ₚᵢ) projecting the three estimated distances (\hat{d}ᵢ) onto a flat surface formed by the three anchor nodes respectively using a Pythagorean Theorem; a function for converting coordinate values of the three anchor nodes in a first coordinate system to coordinate values in a second coordinate system defined by the basis vector in the plane; a function for calculating coordinate values (\hat{P}_{cB}) of an estimated location projected on the plane of the target node by performing the trilateration using coordinate values converted into the second coordinate system of the three anchor nodes and three projected estimated distances (\hat{d}ₚᵢ); a function for converting the coordinate values (\hat{P}_{cB}) of the projected estimated location to coordinate values (\hat{P}_{cA}) in the first coordinate system; and a function for calculating coordinate values (\hat{P}_{3D}) of a 3D estimated location in the first coordinate system of the target node by reflecting a height (ĥ) of the tetrahedron to the coordinate values (\hat{P}_{cA}).

### Effects of Invention

The locating positioning method according to the invention provides advantages as follows.

First, the invention requires less computing compared to the conventional 3D location estimating algorithms, for example, 3D LLS and Non-Linear Least Squares (NLS). It is because the 3D location estimation is solved with a 2D algorithm through projection onto a predetermined plane and the height of tetrahedron also can be calculated by a simple equation.

Secondly, it is possible to install without considering the difference between anchor nodes in setting the locations of anchor nodes (at the time of first system setup). The conventional 3D location estimating algorithms have to consider the height differences among the anchor nodes since they are not free from such problems due to the occurrence of singular matrix. However, in the present invention, the problem of singular matrix does not take place because the invention calculates the 2D LLS method and the height estimation separately.

Thirdly, it does not need any additional hardware. Since it is possible to calculate the equation of plane and the basis vector from the location of anchor node, the given information and to execute the 3D positioning location estimating algorithm with estimated distances only, an antenna array for estimating angles, height-estimating sensor, etc., which the conventional technologies required, are not needed. Furthermore, since the location estimation is very simple and precise, LBS can be performed more accurately and excellently.

Fourthly, the present invention can estimate the 3D location of target node using least number (3) of anchor nodes only. Therefore, in a case of estimating the location of a specific target node by applying the 3D positioning method of the present invention to a sensor network, the installation of the system for that is relatively simple and not expensive, and thus it is very competitive compared to the other technologies.

Fifthly, the present invention can be applied widely. Even though other hardware or method as well as the sensor network is used, it can be applied as long as the distances from the anchor node to the target node can be estimated. For example, it can be applied to the 3D positioning of mobile phones in the mobile communication network.

### BRIEF DESCRIPTION OF DRAWINGS

FIG. 1 is a diagram showing a basic concept of a 3D location estimating method using three anchor nodes according to the invention,

FIG. 2 is a diagram showing a system for performing a 3D location estimating method according to the invention,

FIG. 3 is a flowchart showing steps for a 3D location estimating method according to the invention,

FIG. 4 is a graph showing a result comparing a performance of a 3D location estimating method according to the invention and that of a conventional location estimating method in a prior art (algorithm), and

FIG. 5 is a graph showing an RMSE of a 3D location estimating method according to the invention and that of a conventional location estimating method in a prior art.

### BEST MODES OF EMBODIMENTS OF INVENTION

Below, referring to the attached figures, details for embodiments of the present invention are going to be described.

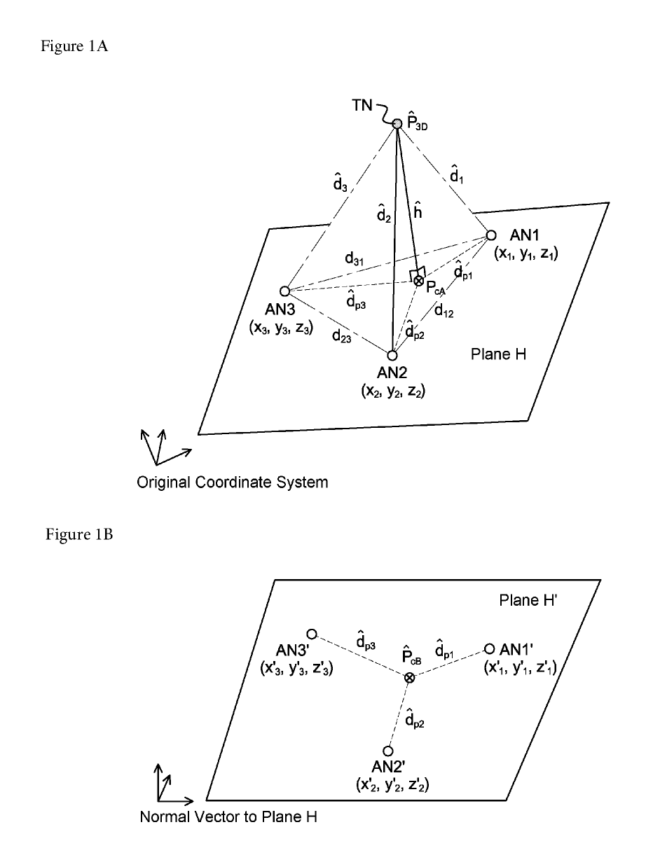

FIG. 1 shows a basic concept of a 3D location estimating method using three anchor nodes according to the invention. The present invention uses three anchor nodes and is based on an algorithm estimating 3D location. This algorithm uses fewer nodes than the conventional 3D location estimating algorithms and has advantages in accuracy, computing cost, and system building. The invention uses Law of Cosines, coordinate rotation, trilateration, etc. to estimate 3D location of target node.

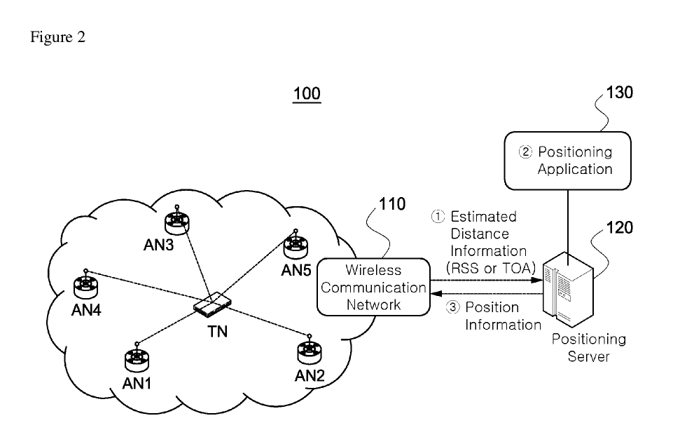

FIG. 2 shows a schematic structure of a wireless positioning system 100 based on a wireless sensor network for performing a 3D location estimating method according to the invention. The wireless positioning system 100 includes a wireless sensor network 110 including three or more wireless communication devices (referred as ‘anchor node’ below) with their locations known and a wireless communication device (referred as ‘target node’ below) with its location unknown, and a positioning server 120 for executing a positioning application 130 described below and calculating a location information of the target node TN. FIG. 2 illustrates the wireless sensor network 110 in a very simplified fashion, but it may have much more complicated structure than that in reality. For example, the wireless sensor network 110 may include a plurality of wireless terminals, a plurality of routers relaying them, and a plurality of coordinators playing a kind of base for the wireless terminals and the routers in a given region.

The positioning application 130 is an application program realizing a positioning algorithm to be described below. This positioning application 130 is recorded in a computer-readable recording medium such as CD, DVD, hard disc, nonvolatile memory, etc., and executed by a CPU. Therefore, as long as it is a computing means capable of acquiring a basic information needed for positioning of target node TN, reading the positioning application 130, and executing it, anything can work as a positioning server 120. Here, the basic information needed for positioning of target node includes the location information of the three anchor nodes related to positioning of target node and an information for estimating a distance from the three anchor nodes to the target node, that is, the estimated distance information. For example, the estimated distance information may be a strength of signal received from the target node at each of the anchor nodes, that is, a Received Signal Strength (RSS), or a time taken for the signal transmitted from the target node to arrive at each of the anchor nodes, that is, a Time of Arrival (ToA).

For example, this positioning application 130 may be executed in a separate computing device outside the wireless sensor network 110 such as the positioning server 120 as shown in the figure. However, the means executing the positioning application 130 is not necessarily limited to such a positioning server 120. The resources forming the wireless sensor network 110 may work as a positioning server. For example, if the anchor nodes or the target node that are components of the wireless sensor network 110 have a sufficient computing power for executing the positioning application 130 from a data storing medium, they may be a means for executing the positioning application 130. If the positioning application 130 is executed for positioning in the positioning server 120, the estimated distance information for estimating the distances from each of the three anchor nodes to the target node and the location information of the three anchor nodes must be provided to the positioning server 120 as shown in FIG. 2, and if the anchor node or the target node works as a positioning server, the above information must be provided to the corresponding node.

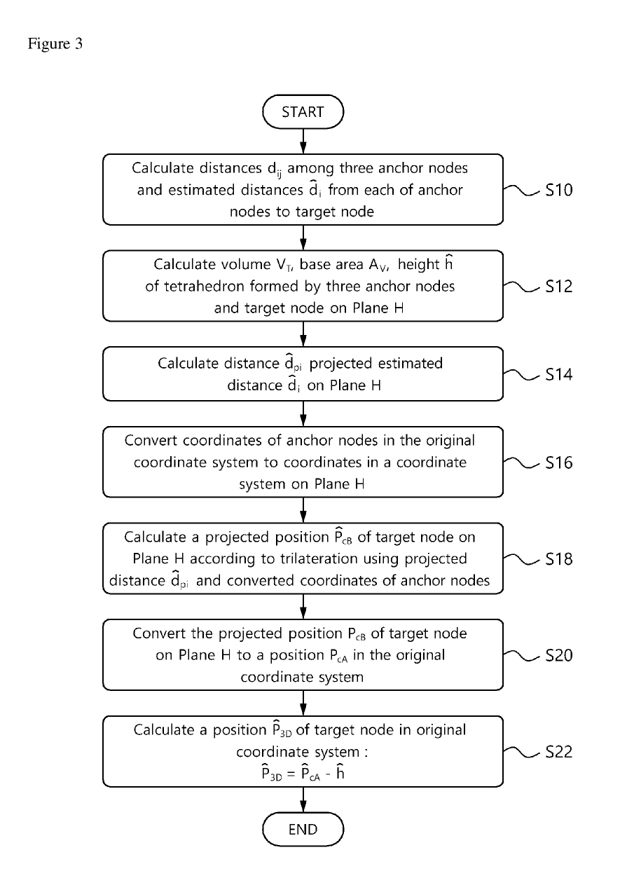

FIG. 3 is a flowchart showing steps for a positioning algorithm of the positioning application 130. The positioning method is performed in steps as follows. The known values set in the invention are the coordinate values of anchor node and classification of usage of the system (that is, properties of target node and classification of target if the target in a person or a flying object).

The invention estimates the location of a target node TN using the location information of three anchor nodes AN1, AN2, AN3.

(i) First, calculate the lengths of the six edges of the tetrahedron formed by the three anchor nodes AN1, AN2, AN3 and the target node TN, that is, mutual distances among the nodes AN1, AN2, AN3, TN (Step S10).

Obtain the mutual distances among the three anchor nodes (dᵢⱼ, that is, d₁₂, d₂₃, d₃₁). Since the coordinate values of the three anchor nodes AN1, AN2, AN3 are known already, those can be obtained. The coordinate values of the anchor nodes are the coordinate values in the original coordinate system (referred as ‘first coordinate system’ below). The first coordinate system may be a conventional orthogonal coordinate system, for example.

Also, obtain the estimated distances (\hat{d}ᵢ, that is, \hat{d}₁, \hat{d}₂, and \hat{d}₃) between the target node TN and each of the anchor nodes AN1, AN2, AN3. The estimated distances between each of the anchor nodes and the target node can be obtained when the links among the target node TN and the three anchor nodes AN1, AN2, AN3 are established so as to transmit and receive signals with one another, that is, when the selection of node is done. The estimated distances (\hat{d}ᵢ) between each of the anchor nodes AN1, AN2, AN3 and the target node TN can be calculated using the RSS information or the ToA information. Here, signals that can be used in calculating the estimated distances may be RF, sound wave, light, etc. Since the method of estimating distance using the RSS information or ToA information is well known to one skilled in the community of the technology, its detailed description is omitted here.

Also, the classification of usage of the system can be one that the target node is lower than the anchor nodes (a person and objects in doors with a height of around 2 meters) and the other that the target node is higher than the anchor nodes (flying objects, etc.). In the former case, the direction of the height (ĥ) of the tetrahedron can be set minus (−), while in the latter case, the direction of the height (ĥ) of the tetrahedron can be set plus (+).

(ii) obtain a volume and a height of the tetrahedron formed by the mutual distances (dᵢⱼ) among the three anchor nodes AN1, AN2, AN3 and the estimated distances (\hat{d}ᵢ) among the three anchor nodes AN1, AN2, AN3 and the target node TN (Step S12).

If the lengths (dᵢⱼ, \hat{d}ᵢ) of the six edges of the tetrahedron are known, the volume of the tetrahedron can be obtained using the lengths of the edges. More specifically, the volume of tetrahedron is calculated using the Equation (1) below, which uses the Law of Cosines and the extension of Heron's Formula.

$${V}_{T} = \frac{{\hat{d}}_{1} \cdot {\hat{d}}_{2} \cdot {\hat{d}}_{3}}{6} \sqrt{1 + f ( θ )} \qquad ( 1 )$$

Here, V_{T} stands for the volume of tetrahedron, and \hat{d}₁, \hat{d}₂, and \hat{d}₃ represent the estimated distances between each of the three anchor nodes AN1, AN2, AN3 and the target node TN. The function f(θᵢ) can be given as follows.

$$\begin{matrix}f ( {θ}_{i} ) = 2 \cdot {\prod }_{i = 1}^{3} cos {θ}_{i} - ( {\prod }_{i = 1}^{3} {cos}^{2} {θ}_{i} ) & ( 2 ) \\ cos {θ}_{i} = \frac{{\hat{d}}_{i}^{2} + {\hat{d}}_{j}^{2} - {\hat{d}}_{ij}^{2}}{2 \cdot {\hat{d}}_{i} \cdot {\hat{d}}_{j}} & ( 3 )\end{matrix}$$

Even though f(θᵢ) looks like an equation with an argument of a cosine function having an angle variable, the cosine function in Equation (2) is given by the base distance (that is, dᵢⱼ, \hat{d}ᵢ, \hat{d}ⱼ) using the Law of Cosines. i is an index for anchor nodes with i=1, 2, 3, and j is an index for a neighboring anchor node defined by j=(i mod 3)+1.

Next, calculate the height (ĥ) of the tetrahedron. In order to obtain the height of the tetrahedron, first we must know the area (A_{V}) of the triangle formed by the three anchor nodes AN1, AN2, AN3. The lengths (d₁₂, d₂₃, d₃₁) of three edges of the triangle that is the base of the tetrahedron have been obtained already in the above. If the lengths of three edges of a triangle are given, the area of the triangle, that is, the area (A_{V}) of the base of the tetrahedron can be obtained.

Since the volume (V_{T}) and the base area (A_{V}) of the tetrahedron are known, the height (ĥ) of the tetrahedron can be obtained from them. The height (ĥ) of the tetrahedron is a major parameter for obtaining the height of the target node TN in the 3D location estimation. The height (ĥ) of the tetrahedron means the distance between the target node TN and the plane H, and the direction can be classified to plus (+) or minus (−) according to the usage of the system determined in the above. The magnitude of the height (ĥ) of the tetrahedron is obtained by the Equation (4) below.

$$\vert \hat{h} \vert = 3 \cdot \frac{{V}_{T}}{{A}_{V}} \qquad ( 4 )$$

(iii) Calculate a projected distance (\hat{d}ₚᵢ) projecting the estimated distance (\hat{d}ᵢ) on the plane H (Step S14).

Even though the height (ĥ) of the tetrahedron is obtained, it is not known yet where on the plane H the height is from. The location is where the target node is projected on the plane H, and it is necessary to find the coordinate of the projected position.

Since the height of the tetrahedron is perpendicular to the plane H, the three estimated distances (\hat{d}ᵢ) can be projected on the plane H by the Pythagorean Theorem. Each of the three projected distances (\hat{d}ₚᵢ) is a distance from the projected point (\hat{P}_{cA}) of the target node TN on the plane H to each of the anchor nodes AN1, AN2, AN3. The line connecting the target node TN and the projected point (\hat{P}_{cA}) is perpendicular to the plane H. Therefore, the three projected distances (\hat{d}ₚᵢ) can be calculated by the Pythagorean Theorem using the height (ĥ) and the estimated distances (\hat{d}ᵢ).

(iv) Convert the original coordinate values of the anchor nodes AN1, AN2, AN3 to the coordinate values in the plane H using a coordinate convert matrix (Step S16).

The coordinate values (x₁, y₁, zₗ), (x₂, y₂, Z₂), (X₃, y₃, z₃) of the anchor nodes AN1, AN2, AN3, which are known, are the coordinate values in the original coordinate system (the first coordinate system). In order to obtain correctly the coordinate values of the projected point (\hat{P}_{cA}) on the plane H, it is necessary to convert the coordinate values of the anchor nodes to the coordinate values (x′₁, y′₁, z′₁), (x′₂, y′₂, z′₂), (x′₃, y′₃, z′₃) in the coordinate system on the plane H (second coordinate system).

For that, using the coordinate values (x₁, y₁, z₁), (x₂, y₂, z₂), (x₃, y₃, z₃) of the anchor nodes AN1, AN2, AN3, obtain the equation of the plane H formed by the three anchor nodes. Furthermore, using the equation of the plane H, the basis vector of the plane H formed by the three anchor nodes is found. The conversion matrix between the original coordinate system and the coordinate system formed by the basis vector of the plane H is also obtained.

More specifically, in order to calculate the 3D coordinates of the target node, it is necessary to obtain the converted coordinates (\hat{P}_{cA}) of the estimated position of the target node projected on the plane H. The converted coordinates (\hat{P}_{cA}) of the target node projected on the plane H is an estimated position projected on the plane H in a direction opposite to the height (ĥ). This is calculated using the projected estimated distance (\hat{d}ₚᵢ) projected the estimated distance (\hat{d}ᵢ) on the plane H. Therefore, the converted coordinates (\hat{P}_{cA}) of the target node on the plane H are calculated in the converted coordinate system (the second coordinate system) based on the plane H.

For example, in order to determine an arbitrary point in a 3D orthogonal coordinate system, three axes must be defined. Here, the subscript A stands for the original first coordinate system for positioning, and the subscript B stands for the converted coordinate system about the plane H, that is, the second coordinate system. The method of converting a position vector in the first coordinate system to a position vector in the second coordinate system is as follows.

P_{B}=C_{A}^{B}·P_{A} (5)

Here, P_{A} and P_{B} stand for the position vectors in the first and second coordinate systems, respectively. C_{A}^{B} stands for the conversion matrix from the first coordinate system to the second coordinate system. The conversion matrix is obtained from the basis vector of the first coordinate system and the second coordinate system. When the first coordinate system is a regular 3D orthogonal coordinate system, the basis vector of the first coordinate system can be given simply as follows.

$${X}_{A} = [ \begin{matrix}{α}_{1} & {α}_{2} & {α}_{3}\end{matrix} ] = [ \begin{matrix}1 & 0 & 0 \\ 0 & 1 & 0 \\ 0 & 0 & 1\end{matrix} ] \qquad ( 6 )$$

Here, the row of X_{A}, that is, α₁, α₂, α₃ generates the standard basis for a 3D matrix (R³). The normalized basis vector of the second coordinate system is given as follows.

$${X}_{B} = [ \begin{matrix}{β}_{1} & {β}_{2} & {β}_{3}\end{matrix} ] = [ \begin{matrix}{\vec{n}}_{1 x} & {\vec{n}}_{2 x} & {\vec{n}}_{hx} \\ {\vec{n}}_{1 y} & {\vec{n}}_{2 y} & {\vec{n}}_{hy} \\ {\vec{n}}_{1 z} & {\vec{n}}_{2 z} & {\vec{n}}_{hz}\end{matrix} ] \qquad ( 7 )$$

Here,

β₁=[\vec{n}₁ₓ\vec{n}_{1y}\vec{n}_{1z}]^{T} and β₂=[\vec{n}₂ₓ\vec{n}_{2y}\vec{n}_{2z}]^{T}

are arbitrary and independent vectors on the plane H.

β₃=[\vec{n}ₕₓ\vec{n}_{hy}\vec{n}_{hz}]^{T}

stands for a normal vector to the plane H. The basis vector β₁ is calculated by anchor nodes at tow points on the plane H, and β₃ is obtained from an equation of the plane H defined by the three reference nodes. β₃ is calculated easily by vector cross product using two vectors from the plane H. Therefore, the row β₁, β₂, β₃ are normalized perpendicular vectors. As a result, the conversion matrix C_{A}^{B} can be calculated with the following equation.

$${C}_{A}^{B} = {{X}_{B} ( {X}_{A } )}^{- 1} = [ \begin{matrix}{\vec{n}}_{1 x} & {\vec{n}}_{2 x} & {\vec{n}}_{hx} \\ {\vec{n}}_{1 y} & {\vec{n}}_{2 y} & {\vec{n}}_{hy} \\ {\vec{n}}_{1 z} & {\vec{n}}_{2 z} & {\vec{n}}_{hz}\end{matrix} ] \qquad ( 8 )$$

The conversion matrix C_{A}^{B} converts a coordinate in the first coordinate system to a coordinate in the second coordinate system, and its inverse matrix C_{A}^{B} converts a coordinate in the second coordinate system to a coordinate in the first coordinate system. The inverse relationship between the C_{A}^{B} and C_{B}^{A} can be obtained easily by the fact that X_{A}=C_{B}^{A}·X_{B}·X_{A} is a unit matrix, and C_{A}^{B} is equal to X_{B}.

Therefore, if multiplying the conversion matrix C_{A}^{B} to the original coordinate values (x₁, y₁, z₁), (x₂, y₂, z₂), (x₃, y₃, z₃) of the anchor nodes AN1, AN2, AN3, then the coordinate values (x′₁, y′₁, 0), (x′₂, y′₂, 0), (x′₃, y′₃, 0) in the second coordinate system, that is, the converted coordinates on the plane. Here, due to the coordinate conversion, the converted coordinates on the plane H, z′₁, z′₂, z′₃ are all 0.

(v) Calculate a projected position of the target node TN on the plane H, that is, the estimated location (\hat{P}_{cB}) of the target node on the plane H, by performing the trilateration using the converted coordinates of the anchor nodes AN1, AN2, AN3 on the plane H and the projected distances (\hat{d}ₚᵢ) on the plane H of the estimated distances (\hat{d}ᵢ) to the target node TN (Step S18).

Since the converted coordinate values (x′₁, y′₁, 0), (x′₂, y′₂, 0), (x′₃, y′₃, 0) of the anchor nodes AN1, AN2, AN3 on the plane H and the projected distances (\hat{d}ₚᵢ) from each of the anchor nodes to the projected point on the plane H of the target node TN are known already, the estimated location (\hat{P}_{cB}) of the target node on the plane H are calculated by applying the trilateration using these projected distances (\hat{d}ₚᵢ) and the converted coordinates of the anchor nodes on the plane H. For the trilateration, for example, the 2D LLS may be used.

If applying the trilateration, the method of obtaining the estimated location using the 2D trilateration is as follows. First, in order to calculate the position (\hat{P}_{cB}_{ₓ}, \hat{P}_{cB}_{_{y}}) to estimate using the converted coordinates (x′ᵢ, y′ᵢ) (i=1, 2, 3) and the projected distance (\hat{d}ₚᵢ), it can be like the circle equation (9).

$$\{ \begin{matrix}{( {\hat{p}}_{{cB}_{x}} - {x}_{1}^{′} )}^{2} + ( {\hat{p}}_{{cB}_{y}} - {y}_{1}^{′} ) = {\hat{d}}_{p 1}^{2} \\ {( {\hat{p}}_{{cB}_{x}} - {x}_{2}^{′} )}^{2} + ( {\hat{p}}_{{cB}_{y}} - {y}_{2}^{′} ) = {\hat{d}}_{p 2}^{2} \\ {( {\hat{p}}_{{cB}_{x}} - {x}_{3}^{′} )}^{2} + ( {\hat{p}}_{{cB}_{y}} - {y}_{3}^{′} ) = {\hat{d}}_{p 3}^{2}\end{matrix} \qquad ( 9 )$$

The equation (9) can be simplified as follows using the simultaneous equations.

$$\{ \begin{matrix}{x}_{2}^{′2} - {x}_{1}^{′2} - 2 ( {x}_{2}^{′} - {x}_{1}^{′} ) {\hat{p}}_{{cB}_{x}} + {y}_{2}^{′2} - {y}_{1}^{′2} - 2 ( {y}_{2}^{′} - {y}_{1}^{′} ) {\hat{p}}_{{cB}_{x}} = {\hat{d}}_{p 2}^{2} - {\hat{d}}_{p 1}^{2} \\ {x}_{3}^{′2} - {x}_{1}^{′2} - 2 ( {x}_{3}^{′} - {x}_{1}^{′} ) {\hat{p}}_{{cB}_{x}} + {y}_{3}^{′2} - {y}_{1}^{′2} - 2 ( {y}_{3}^{′} - {y}_{1}^{′} ) {\hat{p}}_{{cB}_{x}} = {\hat{d}}_{p 3}^{2} - {\hat{d}}_{p 1}^{2}\end{matrix} \qquad ( 10 )$$

If simplifying the equation (10) with the position (\hat{P}_{cB}_{ₓ}, \hat{P}_{cB}_{_{y}}) to estimate and representing in matrix

H·\hat{P}_{cB}=b (11)

Here,

$$H = [ \begin{matrix}2 ( {x}_{2}^{′} - {x}_{1}^{′} ) & 2 ( {y}_{2}^{′} - {y}_{1}^{′} ) \\ 2 ( {x}_{3}^{′} - {x}_{1}^{′} ) & 2 ( {y}_{3}^{′} - {y}_{1}^{′} )\end{matrix} ] , \\ b = [ \begin{matrix}{x}_{2}^{′2} - {x}_{1}^{′2} + {y}_{2}^{′2} - {y}_{1}^{′2} - {\hat{d}}_{p 2}^{2} + {\hat{d}}_{p 1}^{2} \\ {x}_{3}^{′2} - {x}_{1}^{′2} + {y}_{3}^{′2} - {y}_{1}^{′2} - {\hat{d}}_{p 3}^{2} + {\hat{d}}_{p 1}^{2}\end{matrix} ]$$

The equation for obtaining the estimated location (\hat{P}_{cB}) using the equation (11) is as follows.

\hat{P}_{cB}=H⁻¹b (12)

(vi) Convert the projected position (PCB) of the target node TN on the plane H to the coordinate values (\hat{P}_{cA}) in the original coordinate system (Step S20).

The estimated location coordinates (\hat{P}_{cB}) on the plane H is converted the estimated location coordinates (\hat{P}_{cA}) in the original coordinate system again through the inverse conversion matrix.

(vii) Lastly, calculate the 3D estimated location (\hat{P}_{3D}) of the target node TN in the original coordinate system using the height (ĥ) and the estimated location coordinates (\hat{P}_{cA}) found in the above (Step S22).

The 3D estimated location (\hat{P}_{3D}) of the target node TN in the original coordinate system is calculated into the final 3D estimated location coordinates using the converted estimated location (\hat{P}_{cA}) in the original coordinate system and the height (h) of the tetrahedron. \hat{P}_{cA} is a coordinate obtained by converting the projected position (\hat{P}_{cB}) of the target node TN on the plane H into the original coordinate system. Since \hat{P}_{cA} stands for the projected position of the target node TN, as shown in the equation (9), it becomes the coordinates \hat{P}_{3D} of the real position of the target node, only after reflecting the height (ĥ) of the target node to this coordinates \hat{P}_{cA}.

$$\begin{matrix}{\hat{P}}_{3 D} = {\hat{P}}_{cA} - \hat{h} \\ = ( {\hat{x}}_{cA} - \vert \hat{h} \vert {\vec{n}}_{hx} , {\hat{y}}_{cA} - \vert \hat{h} \vert {\vec{n}}_{hy} , {\hat{z}}_{cA} - \vert \hat{h} \vert {\vec{n}}_{hz} )\end{matrix} \qquad ( 13 )$$

The results obtained by comparing the present invention with a conventional 3D position estimating method are as follows.

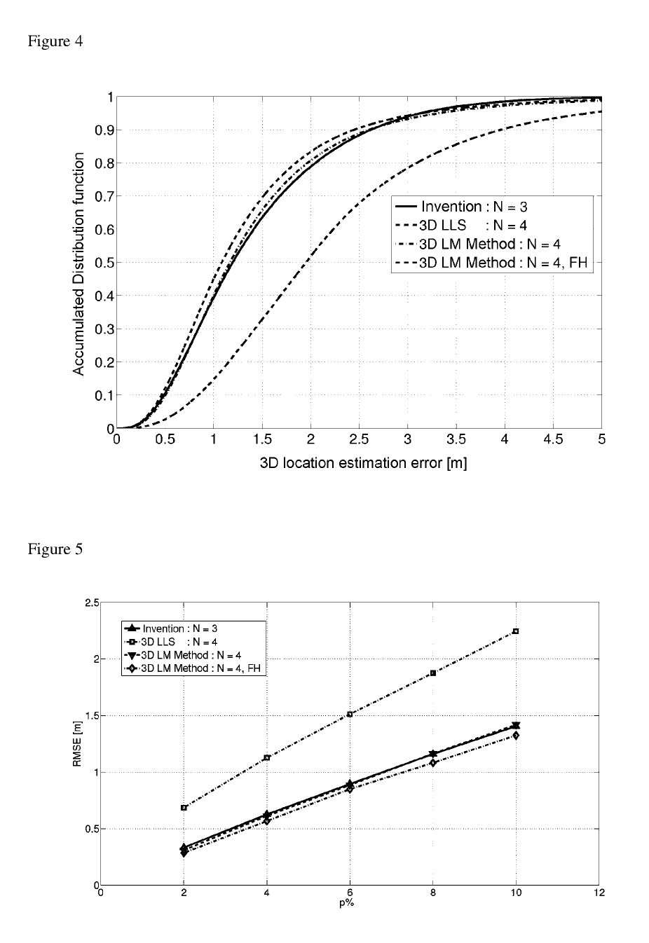

The graph of FIG. 4 is a result comparing the performance of the 3D position estimating method according to the invention with that of a conventional position estimating method. While the position estimating method according to the present invention uses three anchor nodes, the conventional position estimating method uses four of them. In FIG. 4, 3D LLS is an abbreviation of 3D linear least square algorithm, and the 3D LM method means the 3D Levenberg-Marquardt method.

Since the 3D LM method is an iteration method, the computing is extensive, but the accuracy is high and it can avoid so called the problem of singular matrix. The maximum number of iteration of the 3D LM method was set 100 times, and if the estimation value converges it terminates, and if not, it gave out the result after going through the iteration up to the maximum times. The fixed height in the simulation was set from 3 meters and on with an interval of 1 meter. The invention used the fixed height of 3m, 4m, 5m respectively, and the conventional method to compare used the heights of 3m, 4m, 5m, 6m and 100,000 times of Monte-Carlo simulation were performed.

If analyzing the result values, the method suggested by the invention produced more accurate result values than the conventional 3D LLS method, and the result values that were not so bad than the 3D LM method. In order to produce the above results, the 3D LM method performed 40 times on average out of the maximum 100 times of iteration, and therefore the computation was too demanding. The 3D LM method used the heights of anchor node set at 5m, which is the largest height of the 3D positioning algorithm according to the invention so as to suggest the same height of anchor node as in the invention, and the simulation was performed so as to have the height interval of 3m˜5m. Since the 3D positioning algorithm suggested by the invention uses a simple volume calculation and 2D, not 3D, LLS method, it is much simpler than the 3D LM method, and since it uses three anchor nodes only, it is very effective to realize the system.

In the above, the examples using three anchor nodes for positioning the target node were described, but if there are more anchor nodes available, a plurality of anchor node sets, each of which including three anchor nodes, can be used to estimate the position. By taking average of the estimated location values over the plurality of anchor node sets, the estimated location of the target node would be more accurate.

In the above embodiments, the invention was described with the wireless sensor network for an example, but as long as the wireless communication network has at least three anchor nodes with positions known, it can be applied to them. For example, it can be applied to a mobile communication network providing a wireless communication service to mobile phones.

Also, in the above embodiments, the host executing the positioning application 130 and estimating the position of the target node TN was the positioning server 120, but if the anchor node ANᵢ or the target node TN has a resource enough to execute the positioning application 130 and perform computing described in the above, any one of those can work as a host to perform the positioning of the target node TN.

### APPLICATIONS TO INDUSTRY

The invention can be applied to all the systems estimating the distance between the anchor nodes and the target node based on sound waves, luminosity change (light), etc. as well as electromagnetic waves. Typically, it can be applied for home network, unmanned system (medical, logistics, etc.).

1. A method for estimating a 3D location of target node in a wireless network having at least three anchor nodes with coordinate values known in an original first coordinate system and a target node with 3D coordinate values unknown in the first coordinate system, the method comprising steps for:
calculating three estimated distances (\hat{d}ᵢ) between the target node and each of the three anchor nodes using information of wireless signals received among the nodes;
calculating a volume (V_{T}) of a tetrahedron formed by the three estimated distances (\hat{d}ᵢ) and three distances (dᵢⱼ) among the three anchor nodes and a base area (A_{V}) of the tetrahedron formed by the three anchor nodes and calculating a height (ĥ) using the volume V of the tetrahedron and the base area A of the tetrahedron;
calculating three projected estimated distances (\hat{d}ₚᵢ) projecting the three estimated distances (\hat{d}ᵢ) onto a flat surface formed by the three anchor nodes respectively using a Pythagorean Theorem;
converting coordinate values of the three anchor nodes in a first coordinate system to coordinate values in a second coordinate system defined by the basis vector in the plane;
calculating coordinate values (\hat{P}_{cB}) of an estimated location projected on the plane of the target node by performing the trilateration using coordinate values converted into the second coordinate system of the three anchor nodes and three projected estimated distances (\hat{d}ₚᵢ);
converting the coordinate values (\hat{P}_{cB}) of the projected estimated location to coordinate values (\hat{P}_{cA}) in the first coordinate system; and
calculating coordinate values (\hat{P}_{3D}) of a 3D estimated location in the first coordinate system of the target node by reflecting a height (ĥ) of the tetrahedron to the coordinate values (\hat{P}_{cA}).

2. The method of claim 1, wherein a coordinate conversion of the three anchor nodes is performed by using a coordinate conversion matrix from the first coordinate system to the second coordinate system.

3. The method of claim 2, wherein a coordinate conversion to the first coordinate system is performed by using an inverse coordinate conversion matrix of the coordinate conversion matrix.

4. The method of claim 2, wherein the coordinate conversion matrix is obtained by steps for: finding equation of the plane formed by the three anchor nodes by using the coordinate values of the three anchor nodes; finding the basis vector of the plane defined by the three anchor nodes by using the equation of the plane; and finding a coordinate conversion matrix between the first coordinate system and the second coordinate system formed by the basis vector of the plane.

5. The method of claim 1, wherein the trilateration is a two-dimensional linear least squares (LLS).

6. The method of claim 1, wherein the information of the wireless signals is an information of received signal strength (RSS) or a time of arrival (ToA) of signals received between each of the three anchor nodes and the target node.

7. The method of claim 1, wherein the basis vector of the plane is obtained from the equation of plane formed by the specific three anchor nodes.

8. The method of claim 1, wherein the 3D location estimation method of the target node is realized by a positioning application program, and wherein the coordinate values (\hat{P}_{3D}) of the 3D estimated location of the target node is calculated by a computing means executing the positioning application program.

9. A recording medium recorded with and to be read by a computing means a positioning application program for 3D location estimation of a target node in a wireless network having at least three anchor nodes with coordinate values known in an original first coordinate system and a target node with 3D coordinate values unknown in the first coordinate system, wherein the positioning application program comprising:
a function for calculating three estimated distances (\hat{d}ᵢ) between the target node and each of the three anchor nodes using information of wireless signals received among the nodes;
a function for calculating a volume (V_{T}) of a tetrahedron formed by the three estimated distances (\hat{d}ᵢ) and three distances (dᵢⱼ) among the three anchor nodes and a base area (A_{V}) of the tetrahedron formed by the three anchor nodes and calculating a height (ĥ) using the volume V of the tetrahedron and the base area A of the tetrahedron;
a function for calculating three projected estimated distances (\hat{d}ₚᵢ) projecting the three estimated distances (\hat{d}ᵢ) onto a flat surface formed by the three anchor nodes respectively using a Pythagorean Theorem;
a function for converting coordinate values of the three anchor nodes in a first coordinate system to coordinate values in a second coordinate system defined by the basis vector in the plane;
a function for calculating coordinate values (\hat{P}_{cB}) of an estimated location projected on the plane of the target node by performing the trilateration using coordinate values converted into the second coordinate system of the three anchor nodes and three projected estimated distances (\hat{d}ₚᵢ);
a function for converting the coordinate values (\hat{P}_{cB}) of the projected estimated location to coordinate values (\hat{P}_{cA}) in the first coordinate system; and
a function for calculating coordinate values (\hat{P}_{3D}) of a 3D estimated location in the first coordinate system of the target node by reflecting a height (ĥ) of the tetrahedron to the coordinate values (\hat{P}_{cA}).

10. The recording medium of claim 9, wherein a coordinate conversion of the three anchor nodes is performed by using a coordinate conversion matrix from the first coordinate system to the second coordinate system, and wherein a coordinate conversion to the first coordinate system is performed by using an inverse coordinate conversion matrix of the coordinate conversion matrix.

11. The recording medium of claim 10, wherein the coordinate conversion matrix is obtained by steps for: finding equation of the plane formed by the three anchor nodes by using the coordinate values of the three anchor nodes; finding the basis vector of the plane defined by the three anchor nodes by using the equation of the plane; and finding a coordinate conversion matrix between the first coordinate system and the second coordinate system formed by the basis vector of the plane.

12. The recording medium of claim 9, wherein the trilateration is a two-dimensional linear least squares (LLS).

13. The recording medium of claim 9, wherein the information of the wireless signals is an information of received signal strength (RSS) or a time of arrival (ToA) of signals received between each of the three anchor nodes and the target node.

14. The recording medium of claim 9, wherein the basis vector of the plane is obtained from the equation of plane formed by the specific three anchor nodes.
